(19) United States
(12) Patent Application Publication
(10) Pub. No.: US 2004/0114604 A1
(43) Pub. Date: Jun. 17, 2004

(54) Method for selecting the qos level during a connection in a packet network or a network

(76) Inventors: Eckhardt Belgardt, Munchen (DE); Rainer Kuhn, Munchen (DE); Hanspeter Ruckstuhl, Wolfratshausen (DE)

Correspondence Address: BELL, BOYD & LLOYD, LLC, P. O. BOX 1135, CHICAGO, IL, 60690-1135, US

(21) Appl. No.: 10/451,443

(22) PCT Filed: Dec. 13, 2001
(86) PCT No.: PCT/EP01/14716

(30) Foreign Application Priority Data
Dec. 19, 2000 (EP) 00127848.0

(51) Int. Cl. H04L 12/28

(52) U.S. Cl. 370/395.21

(57) ABSTRACT

Two methods are provided for selecting the QoS level during a connection between a first media gateway which is associated with a first subscriber and a first network operation, and a second media gateway which is associated with a second subscriber and possibly a second network operation, either in a packet network via an exchange by a CODEC or in a network via an exchange by a transmission technique. In such methods, the first subscriber and/or the first network operator signals to a first media gateway controller that they would like another QoS. During the first method, a CODEC used in the connection is modified via the first and second media gateways and two media gateway controllers. During the second method, an IP connection is deviated towards a TDM connection, or vice versa, via additional TDM endpoints and the aforementioned components. It is thus possible to adapt the QoS level to the level currently required.

### BACKGROUND OF THE INVENTION

The present invention relates to a subscriber-controlled method for selecting the QoS level during a connection between a first media gateway which is associated with a first subscriber and a second media gateway which is associated with a second subscriber in a packet network by changing CODEC, or in a network via a change of transmission technique.

An end user, as such a PC user or a telephone customer, should have the option of determining themselves whether a connection is switched via the internet or networks with different QoS levels or via a TDM network. Until now there have only been methods which, on the one hand, allow the QoS level to be controlled implicitly by the network operator or, on the other hand, allow the QoS level to be controlled explicitly by the subscriber when the connection is being set up. In the case of pure IP connections, it is possible to change the QoS level by selecting different CODECs even during the connection. A CODEC here refers to a coder-decoder, an information transmission unit. However this is not possible in the case of connections which are only partially switched via the IP network. QoS refers to Quality of Service.

An object of the present invention is, therefore, to provide a method with which the QoS level selection can be changed even during a connection by a subscriber or a network operator without terminating the connection.

### SUMMARY OF THE INVENTION

Accordingly, the inventive method allows both changes from a low QoS level to a higher one and vice versa. With this method both subscribers and their network operators are able themselves to determine the quality of the connection during the call. This increases acceptance of internet connections, as the higher quality of TDM connections also can be made available to IP customers in the event of internet bottlenecks and failures. Also, the method allows IP network customers to be automatically switched to he TDM network on the basis of QoS level measurements. This is of major benefit to the carriers, as their customers generally require a high QoS level. If the connection between two subscribers is subject to excessive interference, they terminate connection, resulting in a loss of revenue for the carrier, on the one hand, and a loss of customer satisfaction on the other. With the present invention this problem no longer arises.

In one embodiment of the method, the QoS level is not selected by changing CODEC but by changing transmission technique; for example, from an IP network to a TDM network or vice versa. Here, too, subscribers or their network operators can modify the QoS level during a connection, such as if the QoS level is not good enough, without terminating the connection. With the inventive stages, an IP connection is rerouted to a TDM connection or vice versa, while the connection continues. As already described this may be executed either by a subscriber or by a network operator; in particular, automatically in the event of a poor connection. As such, the QoS level can be adjusted to the required quality during a connection.

It is advantageous if, during reconfiguration of the TDM connection, the first media gateway connects a first and a second TDM end point and the second media gateway connects a third and a fourth TDM end point and the original IP connection is terminated. This results in very easy and fast reconfiguration of the connection.

It is also advantageous if the TDM connection between the first media gateway controller and the second media gateway controller is set up in compliance with a standard; in particular, an E.164 call number. As such, there are no specific requirements for the TDM switching points. This results in extremely low-cost connection set-up, as special treatment is only required in the media gateway controllers.

Additional features and advantages of the present invention are described in, and will be apparent from, the following Detailed Description of the Invention and the Figures.

### BRIEF DESCRIPTION OF THE FIGURES

FIG. 1 shows a diagrammatic representation of the components used in an embodiment of the method of the present invention.

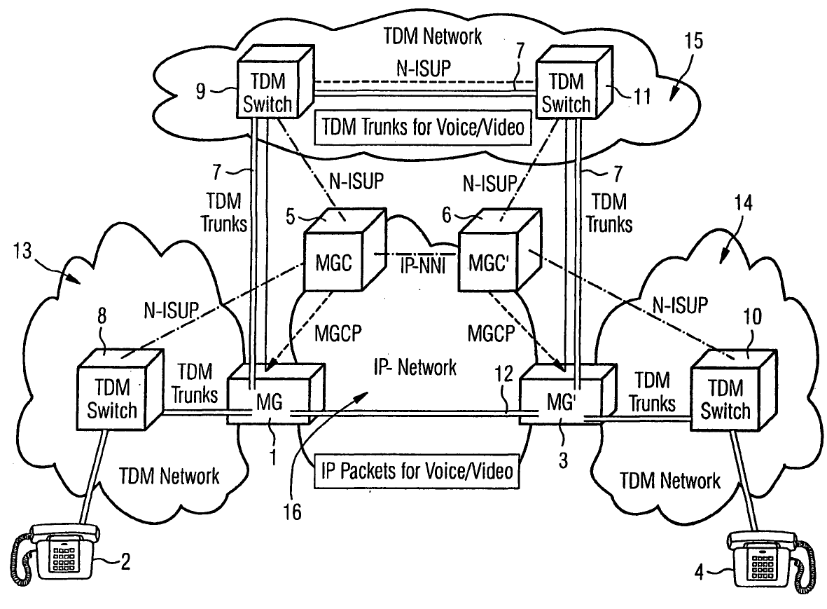

### DETAILED DESCRIPTION OF THE INVENTION

A connection is established between a first subscriber 2 and a second subscriber 4. The first subscriber 2 is connected via a first TDM end point 8 of a first TDM network 13 via TDM trunks to a first media gateway 1. IP packets are forwarded via an IP connection 12 between the first media gateway 1 and a second media gateway 3. The connection goes from the second media gateway 3 via TDM trunks to a second TDM end point 10 in a second TDM network 14. From there the information goes to the second subscriber 4. Such a constellation is used for Voice over IP (VoIP).

If, for example, the first subscriber 2 ascertains that the QoS level of the IP connection 12 is inadequate and there is interference, the first subscriber 2 signals via the first TDM end point 8 to a first media gateway controller 5, which is associated with the first media gateway 1, via an appropriate protocol, such as N-ISUP, that a higher QoS level is required. The first media gateway controller 5 signals these service requirements via an appropriate interface, such as an IP Network-Network Interface (IP-NNI), to a second media gateway controller 6 associated with the second media gateway 3. The second media gateway controller 6 identifies a call number via which a TDM connection 7 can be set up to the second media gateway 3. This is done, for example, by making contact with a fourth TDM end point 11 in a third TDM network 15 via an appropriate protocol; e.g., N-ISUP. The first media gateway controller 5 is also connected via an appropriate protocol, such as N-ISUP, to a second TDM end point 9 in the third TDM network 15. The two TDM end points 9, 11 in the third TDM network 15 also communicate via an appropriate protocol; for example, N-ISUP. The second media gateway controller 6 signals the identified call number to the first media gateway controller 5.

Once the first media gateway controller 5 has identified the call number of the second TDM end point 9 in the third TDM network 15, it sets up the TDM connection 7. The IP connection 12 is then reconfigured onto the newly set up TDM connection 7. The first media gateway 1 thereby connects the first TDM end point 8 in the first TDM network 13 to the second TDM end point 9 in the third TDM network 15. Also, the second media gateway 3 connects the third TDM end point 10 in the second TDM network 14 to the fourth TDM end point 11 in the third TDM network 15. The connection within the third TDM network 15 is made, like the other connections also described, via TDM trunks. The existing IP connection 12 is then terminated. The new connection between the first subscriber 2 and the second subscriber 4 now operates via the first TDM end point 8 in the first TDM network 13, the first media gateway 1 in the IP network 16, the second TDM end point 9 in the third TDM network 15, the fourth TDM end point 11 in the third TDM network 15, the second media gateway 3 in the IP network 16 and the third TDM end point 10 in the second TDM network 14 to the second subscriber 4.

A Voice over ATM application is also possible in addition to this EWSD VoIP application.

With the method described above it is possible to change to a higher QoS level rather than having end users terminate connections of inadequate quality. End users or operators may themselves reroute their connection via the TDM network by signaling the wish for a better connection. This prevents the network operators losing money.

Although the present invention has been described with reference to specific embodiments, those of skill in the art will recognize that changes may be made thereto without departing from the spirit and scope of the present invention as set forth in the hereafter appended claims.

1. Method for selecting the QoS level during a connection between a first media gateway (1), which is associated with a first subscriber (2) and a first network operator (13), and a second media gateway (3), which is associated with a second subscriber by changing CODEC with the following stages:
Signaling of the wish for a higher or lower Q0s level by the first subscriber (2) and/or the first network operator (13) to a first media gateway controller (5) controlling the connection and associated with the first media gateway (1);
Signaling of the service requirement from the first media gateway controller (5) to the first media gateway (1);
Signaling of the new CODEC to be used from the first media gateway (1) to the second media gateway (3);
Informing a second media gateway controller (6) associated with the second media gateway (3) of the new CODEC to be used:
Signaling of the second media gateway controller (6) to the second media gateway (3) that the CODEC may be changed;
Informing of the first media gateway (1) by the second media gateway (3) that the CODEC may be changed and use of the newly agreed CODEC between the first media gateway (1) and the second media gateway (3);

2. Method for selecting the QoS level during a connection between a first media gateway (1), which is associated with a frist subscriber (2) and a first network operator (13), and a second media gateway (3), which is associated with a second subscriber (4) and possibly a second network operator (14), in a network by changing the transmission technique with the following stages:
Signaling of the wish for a higher or lower QoS level by the first subscriber (2) and/or the first network operator (13) to a first media gateway controller (5) controlling the connection and associated with the first media gateway (1);
Signaling of the service requirements from the first media gateway controller (5) to a second media gateway controller (6) associated with the first media gateway (3);
Identification of a call number, via which a TDM connection (7) or IP connection (12) to the second media gateway (3) can be set up, by the second media gateway controller (6);
Signaling of the call number from the second media gateway controller (6) to the first media gateway controller (5);
Setting up of the TDM connection (7) or IP connection (12) from the first media gateway controller (5) to the second media gateway controller (6);
Switching through of the tdm connection (7) or ip connection (12) between the first media gateway (1) and the second media gateway (3) and reconfiguration of the tdm connection (7) or ip connection (12):

3. Method according to claim 2, characterized in that during reconfiguration of the TDM connection (7) the first media gateway (1) connects a first and a second TDM end point (8, 9) and the second media gateway (3) connects a third and a fourth TDM end point (10, 11) and the original IP connection (12) is terminated.

4. Method according to claim 2 or 3, characterized in that the TDM connection (7) between the first media gateway controller (5) and the second media gateway controller (6) is set up in compliance with the standard, in particular via an E.164 call number.

5. Method according to one of the preceding claims, characterized in that the wish for a higher or lower QoS level is signaled inband, in particular by means of a DTMF service code or outband, in particular by DSS1 or ISUP.
